(19) United States
(12) Patent Application Publication
(10) Pub. No.: US 2024/0170936 A1
(43) Pub. Date: May 23, 2024

(54) POWER RECEPTACLE

(71) Applicant: Chengli LI, Suzhou (CN)

(72) Inventors: Chengli LI, Suzhou (CN); Xiaoming ZHANG, Suzhou (CN); Hongda LIU, Suzhou (CN)

(73) Assignee: Chengli LI, Suzhou (CN)

(21) Appl. No.: 18/061,592

(22) Filed: Dec. 5, 2022

(30) Foreign Application Priority Data
Nov. 21, 2022 (CN) 202223091996.0

(51) Int. Cl. H02G 3/14; H01R 24/76

(52) U.S. Cl. CPC H02G 3/14; H01R 24/76

(57) ABSTRACT

A power receptacle includes a receptacle body having first snap slots, and an outer cover disposed over the receptacle body, having first snap hooks and second snap hooks. The first snap hooks detachably engage with the first snap slots. The receptacle further includes a reset button cap and a test button cap disposed on the outer cover, each cap having second snap slots which engage with the second snap hooks in a detachable and slidable snapping engagement. The snap engagements allow the outer cover to be conveniently installed on the receptacle body, and allow the user to depress the reset button cap and test button cap to activate the reset button and test button inside the receptacle. When the outer cover is worn or damaged, it can be conveniently detached from the receptacle body and replaced.

### BACKGROUND OF THE INVENTION

### Field of the Invention

This invention relates to electrical devices, and in particular, it relates to a power receptacle.

### Description of Related Art

In wall-mounted power receptacles, the front face can become discolored due to long time use, which affects its esthetics. Further, during interior remodeling, paint may cover parts of the front face of the receptacle. Therefore, there is a need for receptacles with replaceable face covers to solve these problems.

In some conventional receptacles, the face cover of the receptacle is attached to the receptable body by multiple screws. Although such attachment is detachable, it requires unscrewing and re-screwing the screws, which may be inconvenient. Therefore, there is a need for receptacles with replaceable face covers that cba be more easily installed and replaced.

### SUMMARY

To achieve the above objects, the present invention provides a power receptacle with a replaceable outer cover, where the outer cover is attached to the receptacle body 101 by snap engagement, making it easy to install and replace.

In one aspect, the present invention provides a power receptacle, which includes: a receptacle body, including a reset button, a test button, a plug slot, and a plurality of first snap slots; an outer cover, disposed over the receptacle body, including an opening corresponding to the plug slot of the receptacle body to expose the plug slot, further including a plurality of first snap hooks and a plurality of second snap hooks, wherein each of the first snap hooks is configured to detachably engage with one of the first snap slots; and a reset button cap and a test button cap, disposed on the outer cover, wherein each of the reset button cap and the test button cap includes a plurality of second snap slots, wherein each of the second snap slots is configured to engage with a corresponding one of the second snap hooks in a detachable and slidable snapping engagement, and wherein the reset button cap and the test button cap are respectively located above the reset button and the test button.

The snap engagements allow the outer cover to be conveniently installed on the receptacle body, and allow the user to depress the reset button cap and test button cap to activate the reset button and test button inside the receptacle. When the outer cover is worn or damaged, it can be conveniently detached from the receptacle body and replaced.

In some embodiments, the plurality of first snap slots are disposed on an exterior of the receptacle body, and the plurality of first snap hooks are disposed on an exterior of the outer cover.

In some embodiments, the outer cover further includes two openings that respectively accommodate the reset button cap and the test button cap, and wherein the plurality of second snap hooks are disposed on inside surfaces of the two openings.

In some embodiments, the receptacle body further includes an inner cover on a top of the receptacle body, the inner cover including openings corresponding to the plug slot, the reset button and the test button to expose the plug slot, the reset button and the test button, wherein the outer cover is disposed over the inner cover.

In some embodiments, each of the second snap slots at least partially accommodates a corresponding one of the second snap hooks, the second snap slot and the corresponding second snap hook being engaged with each other in a detachable snapping engagement and being slidable up and down relative to each other when the reset button cap or the test button cap is pressed down or springs back.

In some embodiments, each of the reset button cap and the test button cap further includes one or more posts that protrude downwardly from its bottom side, and wherein each of the reset button and the test button includes one or more corresponding holes on its upper surface configured to accommodate the corresponding posts.

In some embodiments, the outer cover, the reset button cap and the test button cap have different colors.

### BRIEF DESCRIPTION OF THE DRAWINGS

Preferred embodiments of the present invention are described with reference to the drawings.

FIG. 1 is an exterior view of a power receptacle according to an embodiment of the present invention.

FIG. 2 is an exploded view of the receptacle.

FIG. 3 illustrates the back side of the outer cover of the receptable.

FIG. 4 illustrates the outer cover and button caps of the receptable.

FIG. 5 illustrates the back sides of the reset button cap and test button cap of the receptable.

FIG. 6 is a cross-sectional view illustrating the two button caps installed on the outer cover of the receptacle.

### DETAILED DESCRIPTION OF PREFERRED EMBODIMENTS

Preferred embodiments of the present invention are described below with reference to the drawings. These drawings and descriptions explain embodiments of the invention but do not limit the invention. The described embodiments are not all possible embodiments of the present invention. Other embodiments are possible without departing from the spirit and scope of the invention, and the structure and/or logic of the illustrated embodiments may be modified. Thus, it is intended that the scope of the invention is defined by the appended claims.

In the descriptions below, terms such as “including” are intended to be open-ended and mean “including without limitation”, and can include other contents. “Based on” means “at least partly based on.” “An embodiment” means “at least one embodiment.” “Another embodiment” means “at least another embodiment,” etc.

Further, it should be understood that these descriptions describe embodiments of the present invention but do not limit the scope of the invention. When describing the various components, directional terms such as “up,” “down,” “top,” “bottom” etc. are not absolute but are relative. These terms may correspond to the views in the various illustrations, and can change when the views or the relative positions of the components change.

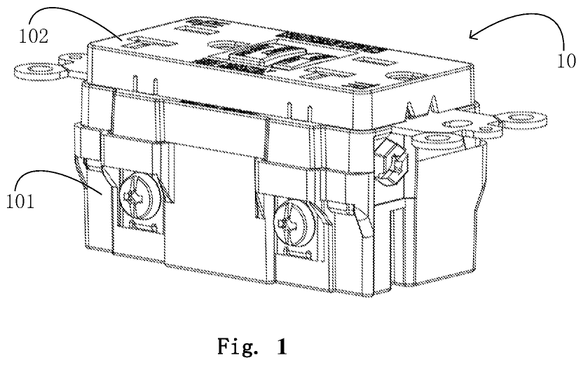

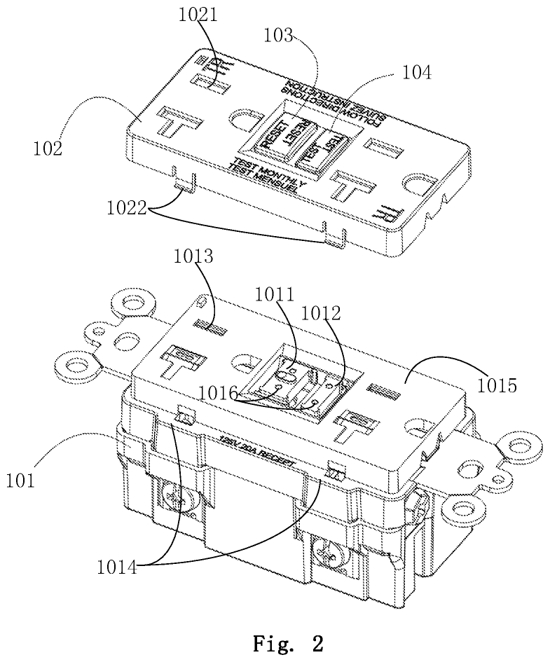

FIG. 1 is an exterior view of a power receptacle according to an embodiment of the present invention. FIG. 2 is an exploded view of the receptacle. The receptacle 10 may incorporate leakage current detection and interruption functions. Referring to FIGS. 1 and 2, the receptacle 10 includes a receptacle body 101, outer cover 102, reset button cap 103, and test button cap 104. The receptacle body 101 contains electrical and mechanical components for a power charger and a leakage current detection and interruption device, including a reset button 1011 and a test button 1012, and a plug slot 1013 of a charger (such as a USB charger slot). The reset button 1011 implements a trip reset function to alert the user of a trip condition and to prevent accidental reset after a trip. The test button 1012 implements a test function for the user to test whether the leakage current detection and interruption device is functioning normally. The outer cover 102 is disposed over the receptacle body 101, and includes an opening 1021 that corresponds to the plug slot 1013 of the receptacle body 101, to expose the plug slot 1013 to facilitate charging. The outer cover 102 may be formed of a plastic material. The reset button cap 103 and test button cap 104 are both disposed on the outer cover 102 of the receptacle 10.

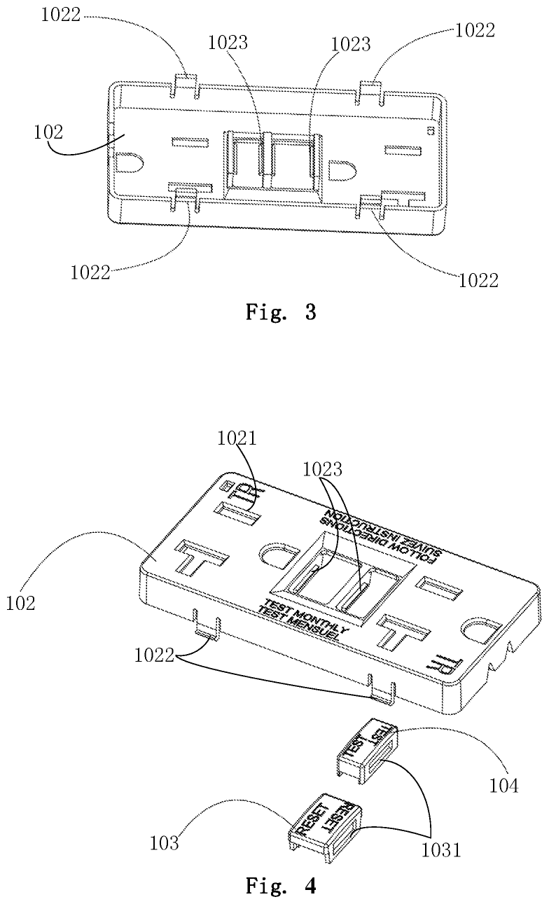

Referring to FIG. 2, the receptacle body 101 further includes a first snap slot 1014, disposed on the exterior of the receptacle body 101 in this example. FIG. 3 illustrates the back side of the outer cover of the receptable. Referring to FIGS. 2 and 3, the outer cover 102 further includers a first snap hook 1022, disposed on the exterior of the outer cover 102 in this example. The first snap slot 1014 and first snap hook 1022 may be formed of plastic materials, and at least one of them is resilient to facilitate a detachable snapping engagement of the two. In the illustrated embodiment, four pairs of first snap slots 1014 and first snap hooks 1022 are shown, but the number is not limited to such, and there may be six, eight, etc. pairs of first snap slots and first snap hooks. The above-described snapping engagement allows the outer cover 102 to be conveniently attached to the receptacle body 101 to serve a decorative function for the receptacle 10. When the outer cover 102 is dirty or damaged, it can be conveniently removed from the receptacle body 101 and replaced.

FIG. 4 illustrates the out cover and button caps of the receptable. Each of the reset button cap 103 and test button cap 104 includes two second snap slots 1031, disposed on the two sides of the exterior of the respective button cap in this example. Correspondingly, the outer cover 102 includes four second snap hooks 1023, disposed on two inside surfaces of each of two openings of the outer cover 102 that accommodate the two button caps in this example. The second snap slots 1031 and second snap hooks 1023 may be formed of plastic materials, and at least one of the snap slot and snap hook in each pair is resilient. The second snap slot 1031 and second snap hook 1023 in each pair are engaged with each other in a detachable snapping engagement and can slide up and down relative to each other. When installed, the reset button cap 103 and test button cap 104 are respectively located above the reset button 1011 and test button 1012. By these structures, the reset button cap 103 and test button cap 104 are attached to the outer cover 102, and can be replaced along with the outer cover 102. After the outer cover 102 is installed over the receptacle body 101, the user can depress the reset button cap 103 and test button cap 104 to respectively activate the reset button 1011 and test button 1012.

Referring back to FIG. 2, the receptacle body 101 further includes an inner cover 1015 at its top. The inner cover 1015 includes openings corresponding to the plug slot 1013, reset button 1011 and test button 1012, to expose these components. The inner cover 1015 functions to isolate and protect the electrical and mechanical components within the receptacle body 101. The outer cover 102 may be installed over the inner cover 1015.

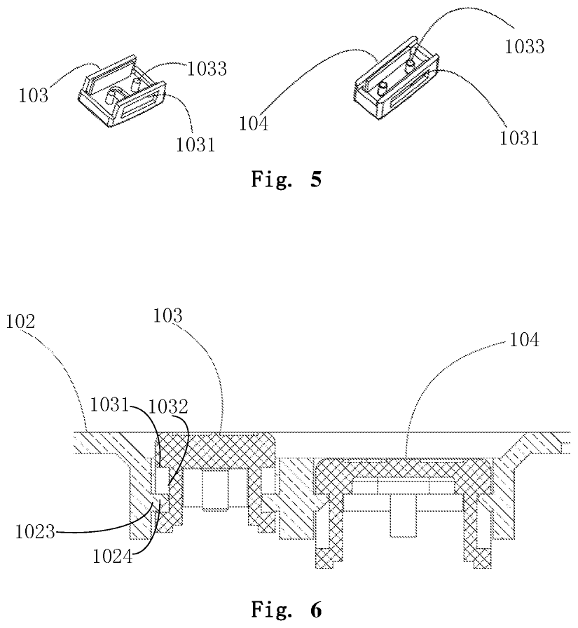

FIG. 5 illustrates the back sides of the reset button cap and test button cap of the receptable. FIG. 6 is a cross-sectional view illustrating the button caps installed on the outer cover of the receptacle, where the reset button cap 103 is in a un-depressed or sprung back state, and the test button cap 104 is in a depressed state. The second snap slot 1031 of the reset button cap 103 has a rectangular cavity 1032, and the second snap hooks 1023 of the outer cover 102 includes a deadbolt structure 1024. When the second snap slot 1031 and second snap hooks 1023 engage with each other, the second snap slot 1031 at least partially accommodates the second snap hooks 1023; more specifically, the rectangular cavity 1032 at least partially accommodates the deadbolt structure 1024. When the reset button cap 103 is being pressed down or is springing back up, the second snap slot 1031 can slide in the up-down direction; more specifically, the rectangular cavity 1032 can slide in the up-down direction. The second snap slots 1031 of the test button cap 104 are similar to the second snap slots 1031 of the test button cap 104 and detailed descriptions are omitted.

Optionally, as shown in FIGS. 2 and 5, each of the reset button cap 103 and test button cap 104 further includes one or more posts 1033 that protrude downwardly from the bottom sides of the respective cap, and the reset button 1011 and test button 1012 respectively include corresponding holes 1016 on their upper surfaces. When the reset button cap 103 and test button cap 104 are installed along with the outer cover 102 over the receptacle body 101, the holes 1016 on the buttons accommodate the corresponding posts 1033 on the button cap, which facilitates correct positioning of the button caps.

The outer cover 102, reset button cap 103 and test button cap 104 may have the same color, or different colors for decorative and indicative effects.

While the present invention is described above using specific examples, these examples are only illustrative and do not limit the scope of the invention. It will be apparent to those skilled in the art that various modifications, additions and deletions can be made to the power receptacle of the present invention without departing from the spirit or scope of the invention.

What is claimed is:

1. A power receptacle, comprising:
a receptacle body, including a reset button, a test button, a plug slot, and a plurality of first snap slots;
an outer cover, disposed over the receptacle body, including an opening corresponding to the plug slot of the receptacle body to expose the plug slot, further including a plurality of first snap hooks and a plurality of second snap hooks, wherein each of the first snap hooks is configured to detachably engage with one of the first snap slots; and
a reset button cap and a test button cap, disposed on the outer cover, wherein each of the reset button cap and the test button cap includes a plurality of second snap slots, wherein each of the second snap slots is configured to engage with a corresponding one of the second snap hooks in a detachable and slidable snapping engagement, and wherein the reset button cap and the test button cap are respectively located above the reset button and the test button.

2. The power receptacle of claim 1, wherein the plurality of first snap slots are disposed on an exterior of the receptacle body, and the plurality of first snap hooks are disposed on an exterior of the outer cover.

3. The power receptacle of claim 1, wherein the outer cover further includes two openings that respectively accommodate the reset button cap and the test button cap, and wherein the plurality of second snap hooks are disposed on inside surfaces of the two openings.

4. The power receptacle of claim 1, wherein the receptacle body further includes an inner cover on a top of the receptacle body, the inner cover including openings corresponding to the plug slot, the reset button and the test button to expose the plug slot, the reset button and the test button,
wherein the outer cover is disposed over the inner cover.

5. The power receptacle of claim 1, wherein each of the second snap slots at least partially accommodates a corresponding one of the second snap hooks, the second snap slot and the corresponding second snap hook being engaged with each other in a detachable snapping engagement and being slidable up and down relative to each other when the reset button cap or the test button cap is pressed down or springs back.

6. The power receptacle of claim 1, wherein each of the reset button cap and the test button cap further includes one or more posts that protrude downwardly from its bottom side, and wherein each of the reset button and the test button includes one or more corresponding holes on its upper surface configured to accommodate the corresponding posts.

7. The power receptacle of claim 1, wherein the outer cover, the reset button cap and the test button cap have different colors.
